(19) United States
(12) Patent Application Publication
(10) Pub. No.: US 2013/0180994 A1
(43) Pub. Date: Jul. 18, 2013

(54) MOLDED FUEL TANK AND METHOD OF MANUFACTURING THE SAME

(71) Applicant: Ingrid McTaggart, Portland, OR (US)

(72) Inventor: Neal Keefer, Portland, OR (US)

(73) Assignee: Ingrid McTaggart, Portland, OR (US)

(21) Appl. No.: 13/711,188

(22) Filed: Dec. 11, 2012

Related U.S. Application Data
(60) Provisional application No. 61/630,457, filed on Dec. 12, 2011.

(51) Int. Cl. B29D 22/00

(52) U.S. Cl. CPC B29D 22/003
USPC 220/562; 264/275

(57) ABSTRACT

One embodiment of a molded fuel tank includes a fuel tank molded from a synthetic material, such as a composite polymer. One embodiment may include molding a fuel tank with a previously formed metal or synthetic component positioned within the fuel tank as it is molded. One embodiment may include molding a fuel tank and an integral component simultaneously from synthetic materials. One embodiment of a molded fuel tank may include a fuel tank with a component secured therein, the tank formed by a rotational molding process.

This application claims the benefit of U.S. provisional patent application Ser. No. 61/630,457, filed on Dec. 12, 2011, in the name of Neal Keefer.

### BACKGROUND OF THE INVENTION

Truck fuel tanks typically are fabricated from multiple pieces of metal, such as steel or aluminum. The sheet of metal typically first is sheared to a rectangular shape, and then is punched or laser cut to form holes in the sheet. The sheet then is rolled into a cylinder, a “D” shape or a rectangular shape, and then welded along the longitudinal seam. The tank ends typically are formed from aluminum sheets which are welded to the built-up, i.e., rolled shell. in a final step, fittings for fuel fill, fuel drain, fuel vent, fuel suction and fuel return tubes are welded into place on the shell or on the tank ends.

This process has a number of challenges. One challenge occurs at the “T” weld joint, i.e., the location where the longitudinal seam and the circumferential seam head welds overlap. This location at the seam overlap region experiences a large number of leaks. Moreover, the overall process of welded metal fuel tank construction is very labor intensive Efforts to automate the welding process by using robotic welders has been somewhat successful in reducing the number of leaks in these tank. However, in general, tank manufacturers have a difficult time being commercially viable due to the capital intensity of the welding operation and due to the low price that the final product purchasers are willing to pay for the finished product.

There is a need, therefore, for a fuel tank with reduced probability of leaks and for a method of manufacturing a tank that is more cost effective.

### SUMMARY OF THE INVENTION

One embodiment of a molded fuel tank includes a fuel tank molded from synthetic material, such as a composite polymer. One embodiment may include molding a fuel tank from synthetic materials, with metal components positioned within the fuel tank as it is molded. One embodiment may include molding a fuel tank and integral components simultaneously from synthetic materials. One embodiment of a molded fuel tank may include a fuel tank formed by a rotational molding process.

### BRIEF DESCRIPTION OF THE DRAWINGS

FIG. 1 is a side schematic view of a molded composite fuel tank.

FIG. 2 is a cross-sectional side view of the fuel tank of FIG. 1 showing components secured within the molded fuel tank.

### DETAILED DESCRIPTION OF THE PREFERRED EMBODIMENTS

One embodiment of the present invention includes a process of molding a one-piece fuel tank that contains all the components on the tank, i.e., molding the tank with the previously formed metal components already in place. The advantages of this method include fewer manufacturing process steps, fewer leak paths, reduced cost and, possibly, reduced weight of the manufactured fuel tank, when compared with prior art metal welded fuel tanks. In another embodiment the method may include molding a fuel tank with the components molded integral with the fuel tank during formation of the fuel tank. The use of a rotational molding process may allow fabrication of a fuel tank with molded metal fitting ports manufactured integral with the tank and within the polymer, eliminating subsequent welding operations. A rotational molding process may also allow fabrication of the fuel tank with synthetic material components manufactured integral with the fuel tank. Use of a molding process may allow the elimination of many of the currently used metal components by integrating threaded ports directly into the composite tank material. Another advantage of the use of a molding process may include fabrication of mounting bracketry integral with the tank during the molding process.

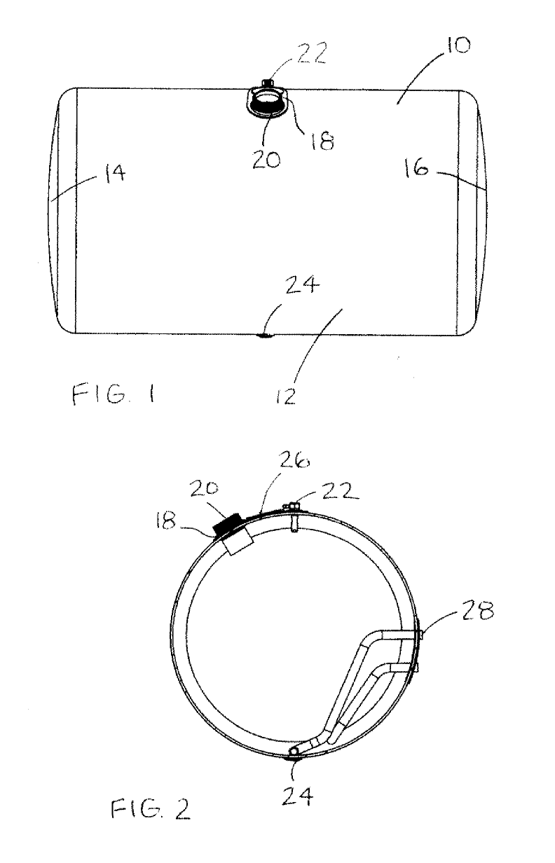

FIG. 1 is side schematic view of a molded composite fuel tank 10 including a side wall 12 and first and second end walls 14 and 16. The tank 10 may include a flange 18 that may secure components thereon, such as a fuel filler neck 20 and a vent port 22, for example. Other components may be utilized in other embodiments. The tank may also include a drain port 24 on an underside thereof. The flange 18, the components secured thereon, and the drain port 24 may be manufactured of metal and secured to the composite material molded tank during or after formation of the tank. The flange 18, the components secured thereon, other components, and the drain port 24, may be manufactured of synthetic material and may be molded integral with the tank during formation of the tank and the components in a single process.

The tank and its attached components may be manufactured of any material, such as a synthetic material for example, during a molding process such as rotational molding. In this process a heated hollow mold is filled with a charge or shot weight of material. The tank is then slowly rotated (usually around two perpendicular axes) causing the softened material to disperse and stick to the walls of the mold. In order to maintain even thickness throughout the part, the mold continues to rotate at all times during the heating phase and to avoid sagging or deformation during the cooling phase. The rotational molding process may be s a high-temperature, low-pressure plastic-forming process that uses heat and biaxial rotation (i.e., angular rotation on two axes) to produce hollow, one-piece parts. The process does have distinct advantages. Manufacturing such large hollow fuel tank is much easier by rotational molding than previously known methods. Rotational molds are significantly cheaper than other types of molds. Very little material is wasted using this process, and excess material can often be re-used, making it a very economically and environmentally viable manufacturing process.

The rotational molding process may consist of four distinct phases:

1. Loading a measured quantity of synthetic material, such as a polymer in powder form, into the mold.

2. Heating the mold in an oven while it rotates, until all the polymer has melted and adhered to the mold wall. The hollow part should be rotated through two or more axes, rotating at different speeds, in order to avoid the accumulation of polymer powder. The length of time the mold spends in the oven is critical: too long and the polymer will degrade, reducing impact strength. If the mold spends too little time in the oven, the polymer melt may be incomplete. The polymer grains will not have time to fully melt and coalesce on the mold wall, resulting in large bubbles in the polymer. This has an adverse effect on the mechanical properties of the finished product.

3. Cooling the mold, usually by fan. This stage of the cycle can be quite lengthy. The polymer must be cooled so that it solidifies and can be handled safely by the operator. This typically takes tens of minutes. The part will shrink on cooling, coming away from the mold, and facilitating easy removal of the part. The cooling rate must be kept within a certain range. Very rapid cooling (for example, water spray) would result in cooling and shrinking at an uncontrolled rate, producing a warped part.

4. Removal of the part.

During the process the air temperature and the internal pressure in the mold may be monitored, allowing the part to be removed from the mold at a time to achieve desirable properties of the molded synthetic material.

The material used to manufacture the fuel tank may include materials from the polyethylene family: cross-linked polyethylene (PEX), low-density polyethylene (LDPE), linear low-density polyethylene (LLDPE), high-density polyethylene (HDPE), and regrind. Other compounds are PVC plastisols, nylons, and polypropylene. In particular, the fuel tank and components may be manufactured from Polyethylene, Polypropylene, Polyvinyl chloride, Nylon, Polycarbonate, Aluminum, Acrylonitrile butadiene styrene (ABS), Acetal, Acrylic, Epoxy, Fluorocarbons, Ionomer, Polybutylene, Polyester, Polystyrene, Polyurethane, and Silicone.

FIG. 2 is a cross-sectional side view of the fuel tank 10 of FIG. 1 showing components secured within the molded fuel tank. The flange 18, the fuel fill neck 20, a fuel level sender port 26, vent port 22, drain port 24, and a fuel supply and return tube assembly 28 (which may include a fuel supply tube and fuel return tube) may all be manufactured prior to manufacture of the tank and secured within the tank during manufacture of the tank 10. In such a process, the components may be secured within a mold and the tank molded around the components. In another embodiment, the components may be manufactured integral with a tank such that the tank mold includes regions for formation of the components simultaneously with the fuel tank itself. The components may be manufactured of any materials as may be suited for a particular process or application. In the embodiment wherein the components are manufactured integral with the fuel tank 10, the components will generally be formed of the same material as the fuel tank.

In the above description numerous details have been set forth in order to provide a more through understanding of the present invention. It will be obvious, however, to one skilled in the art that the present invention may be practiced using other equivalent designs.

I claim:

1. A method of manufacturing a fuel tank, comprising:
providing a mold having an interior surface that corresponds to an exterior shape of a molded fuel tank formed by said mold and that defines an interior of said mold;
securing on said interior surface of said mold a fuel tank component structure;
loading a synthetic material into said interior of said mold;
heating said mold until said synthetic material is melted;
rotating said mold until said synthetic material is adhered to said interior surface;
allowing said melted material to cool so as to form a molded fuel tank; and
removing said molded fuel tank from said mold, wherein said molded fuel tank includes a fuel tank component formed integral within a wall of said molded fuel tank.

2. The method of claim 1 wherein said fuel tank component structure defines said fuel tank component, wherein said component extends inwardly into an interior of said molded fuel tank.

3. The method of claim 1 wherein said fuel tank component structure defines said fuel tank component, wherein said component extends outwardly from an exterior surface of said molded fuel tank.

4. The method of claim 1 wherein said fuel tank component structure defines said fuel tank component, wherein said component is chosen from the group consisting of: a flange, a fuel fill neck, a fuel level sender port, a vent port, a drain port, a fuel supply and return tube assembly, a mounting bracket, a threaded port, a fuel supply tube, a fuel draw tube, and a fuel supply and return tube assembly flange.

5. The method of claim 1 wherein said fuel tank component structure defines said fuel tank component wherein said component is manufactured of one of a synthetic material and a metallic material.

6. The method of claim 1 wherein said heating and rotating steps are conducted simultaneously.

7. The method of claim 1 wherein said molded fuel tank includes an absence of seams.

8. The method of claim 1 wherein said fuel tank component structure defines said fuel tank component, and wherein said component is a previously manufactured fuel tank component that is secured within said mold prior to formation of said molded fuel tank.

9. The method of claim 1 wherein said fuel tank component structure defines a fuel tank component mold that forms said fuel tank component simultaneously with formation of said molded fuel tank.

10. A method of manufacturing a fuel tank, comprising:
providing a mold having an interior surface that corresponds to an exterior shape of a molded fuel tank formed by said mold and that defines an interior of said mold;
loading a synthetic material into said interior of said mold;
heating said mold until said synthetic material is melted;
rotating said mold until said synthetic material is adhered to said interior surface;
allowing said melted material to cool so as to form a molded fuel tank;
removing said molded fuel tank from said mold;
after removing said molded fuel tank from said mold, securing on said molded fuel tank a fuel tank component.

11. The method of claim 10 wherein said fuel tank component extends inwardly into an interior of said molded fuel tank.

12. The method of claim 10 wherein said fuel tank component extends outwardly from an exterior surface of said molded fuel tank.

13. The method of claim 10 wherein said fuel tank component is chosen from the group consisting of: a flange, a fuel fill neck, a fuel level sender port, a vent port, a drain port, a fuel supply and return tube assembly, a mounting bracket, a threaded port, a fuel supply tube, a fuel draw tube, and a fuel supply and return tube assembly flange.

14. The method of claim 10 wherein said fuel tank component is manufactured of one of a synthetic material and a metallic material.

15. The method of claim 10 wherein said heating and rotating steps are conducted simultaneously.

16. The method of claim 10 wherein said molded fuel tank includes an absence of seams.

17. A molded fuel tank, comprising:
a fuel tank body including a tank wall formed of a synthetic material, said tank wall defining an exterior surface of said fuel tank body, and said tank wall defining an interior surface of said fuel tank body that encloses an interior of said fuel tank body; and
a fuel tank component secured to said tank wall, said fuel tank component allowing communication between an exterior and said interior of said fuel tank body.

18. The molded fuel tank of claim 17 wherein said fuel tank component is chosen from the group consisting of: a flange, a fuel fill neck, a fuel level sender port, a vent port, a drain port, a fuel supply and return tube assembly, a mounting bracket, a threaded port, a fuel supply tube, a fuel draw tube, and a fuel supply and return tube assembly flange.

19. The molded fuel tank of claim 17 wherein said fuel tank component is manufactured of one of a synthetic material and a metallic material, said synthetic material being chosen from the group consisting of cross-linked polyethylene (PEX), low-density polyethylene (LDPE), linear low-density polyethylene (LLDPE), high-density polyethylene (HDPE), PVC plastisols, nylons, polypropylene, polyvinyl chloride, nylon, polycarbonate, acrylonitrile butadiene styrene (ABS), acetal, acrylic, epoxy, fluorocarbons, ionomer, polybutylene, polyester, polystyrene, polyurethane, silicone, and mixtures thereof.

20. The molded fuel tank of claim 17 wherein said molded fuel tank body includes an absence of seams.
